(19) United States
(12) Patent Application Publication
(10) Pub. No.: US 2016/0275826 A1
(43) Pub. Date: Sep. 22, 2016

(54) Compound Name-Card-Shaped Proximity Card Holder

(71) Applicant: Yun-Hwan Liao, Hsin Chu (TW)

(72) Inventor: Yun-Hwan Liao, Hsin Chu (TW)

(21) Appl. No.: 14/662,190

(22) Filed: Mar. 18, 2015

(51) Int. Cl. G09F 3/20

(52) U.S. Cl. CPC G09F 3/20

(57) ABSTRACT

A compound name-card-shaped proximity card holder includes: a main body that includes a first pocket, a plurality of interlayers, and a second pocket. The first pocket and the main body form a first receiving compartment. The second pocket and the main body form a second receiving compartment. The first receiving compartment and the second receiving compartment receive and hold therein various articles, such as cards and proximity cards. The interlayers are arranged in the interior of the main body and are fixed by a circular button to the main body to be rotatable out of the main body. The interlayers are each in the form of an open-end folder for insertion and storage of a single proximity card. The interlayers of the main body are formed of thin metal sheets or FAM films protect proximity cards placed inside and outside the interlayers from affecting and demagnetizing each other.

### (a) TECHNICAL FIELD OF THE INVENTION

The present invention relates generally to a proximity card holder, and more particularly to a compound name-card-shaped proximity card holder comprising an outside portion that comprises a proximity card folder and an inside portion that comprise multiple storage interlayers.

### (b) DESCRIPTION OF THE PRIOR ART

Proximity cards are convenient to the modern people and have diverse uses, such as MRT tickets and door cards. The proximity cards are often placed and stored in a one-end-open holder or folder, in which one single proximity card is insertable, allowing for easy storage and removal for detection and reading. However, with the increasing popularization of the proximity cards, it becomes often that a person may own a number of proximity cards. The traditional proximity card folder is generally no longer fit to such a situation. To suit the needs of the modern people, a proximity card holder that is two-sided or has multiple layers is available in the market. Most of the proximity card holders currently available is structured as a single storage folder having an increased thickness to allow for simultaneous insertion of multiple proximity cards that are arranged overlapping each other therein or is alternatively structured to provide storage compartments on both surfaces thereof. However, these arrangements suffer certain drawbacks. When multiple proximity cards are arranged overlapping each other and are simultaneously inserted into a single storage compartment of the conventional proximity card folder, these multiple proximity cards may be detected and read simultaneously at the moment one of these proximity cards is used, so that the reading operation may fail or become ineffective, or the proximity cards may get damaged by each other due to be placed closely against each other for a long period of time, leading to demagnetized of magnetic strips of the proximity cards. It is thus desired to further improve the conventional proximity card folder and holder.

To overcome the above-discussed drawbacks of the conventional devices, the present invention provides a compound name-card-shaped proximity card holder that features the following advantages:

(1) The present invention includes isolation layers that are arranged to allow a single one proximity card to be detected and read, while the other cards are isolated.

(2) The present invention includes isolation layers that separate proximity cards from each other so as to avoid a potential risk of demagnetization of any magnetic parts of the proximity cards.

(3) The present invention provides an excellent value for industrial use.

In view of these, the present invention aims to provide a technical solution that provides a compound name-card-shaped proximity card holder that features security, convenience, and economic value for the ultimate purposes of benefiting the society and improving the development of industry.

### SUMMARY OF THE INVENTION

In light of the problems that the conventional proximity card holder or folder often results in failure of reading a proximity card and multiple proximity cards when placed closely against each other without being properly separated often result in mutual demagnetization, the present invention aims to provide a compound name-card-shaped proximity card holder, which comprises an interlayer formed of a thin metal sheet or a FAM film to provide an effect of isolation so as to prevent proximity cards placed on inside and outside from mutually influencing or demagnetizing each other, wherein, the interlayer, being in a simple form of an open-end folder, allows for insertion and storage of a single proximity card therein and is fixed by a circular button to the main body to be rotatable out of the main body so as to provide an effect of being readily rotated out for detection and reading.

To achieve the above object, the present invention provides a compound name-card-shaped proximity card holder, which comprises: a main body. The main body comprises a first pocket, a plurality of interlayers, and a second pocket. The first pocket and the main body form a first receiving compartment. The second pocket and the main body form a second receiving compartment. The first receiving compartment and the second receiving compartment receive and hold therein articles, such as cards and proximity cards. The interlayers are arranged in the interior of the main body and are fixed by a circular button to the main body to be rotatable out of the main body. The interlayers are each an open-end folder that receives insertion of a single proximity card. As such, a compound name-card-shaped proximity card holder is formed.

Another object of the present invention is to provide a compound name-card-shaped proximity card holder, which comprises: a main body. The main body comprises a first pocket, an isolation layer, and a second pocket. The first pocket and the main body form a first receiving compartment. The second pocket and the main body form a second receiving compartment. The first receiving compartment and the second receiving compartment receive and hold therein articles, such as cards and proximity cards. The isolation layer is arranged between the first receiving compartment and the second receiving compartment to isolate proximity cards received in the compartments to prevent mutual influence and demagnetization therebetween. As such, a compound name-card-shaped proximity card holder is formed.

With the arrangement of an interlayer formed of a thin metal sheet or a FAM film in the main body to provide an effect of isolation so as to prevent proximity cards placed inside and outside from mutually influencing or demagnetizing each other. Further, the interlayer, being in a simple form of an open-end folder, allows for insertion and storage of a single proximity card therein and is fixed by a circular button to the main body to be rotatable out of the main body so as to provide an effect of being readily rotated out for detection and reading.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a compound name-card-shaped proximity card holder according to the present invention.

FIG. 2 is a cross-sectional view showing the compound name-card-shaped proximity card holder according to the present invention.

FIG. 2A is an enlarged view of a circled portion of FIG. 2.

FIG. 3 is a schematic view illustrating an operation of the compound name-card-shaped proximity card holder according to the present invention.

FIG. 4 is a perspective view showing a compound name-card-shaped proximity card holder according to the present invention.

FIG. 5 is a cross-sectional view showing the compound name-card-shaped proximity card holder according to the present invention.

FIG. 5A is an enlarged view of a circled portion of FIG. 5.

FIG. 6 is a schematic view showing an example of use of the compound name-card-shaped proximity card holder of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

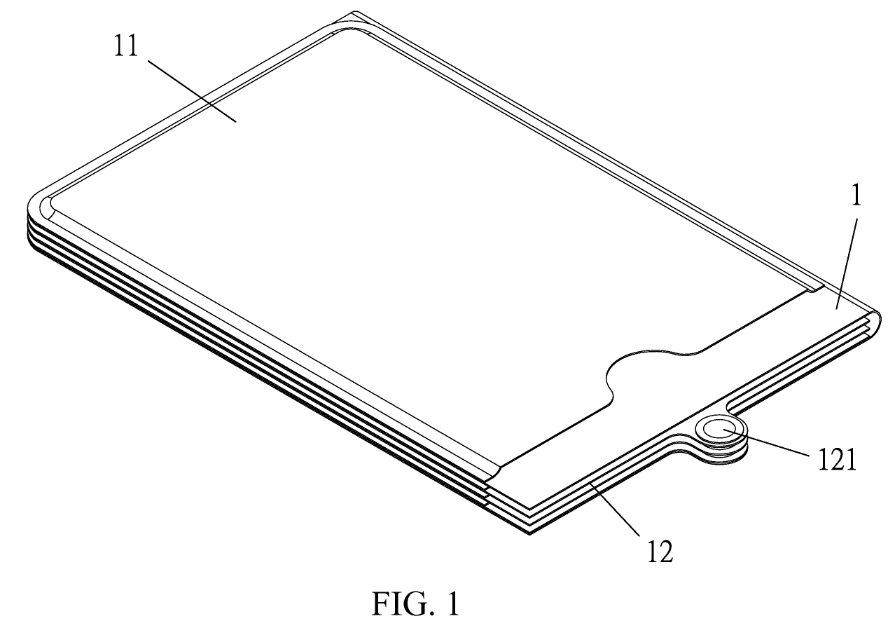

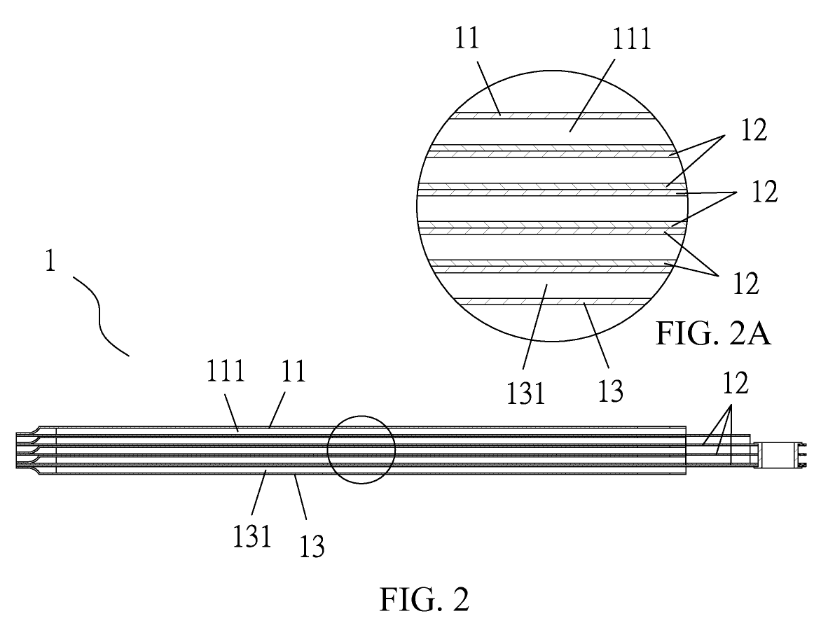

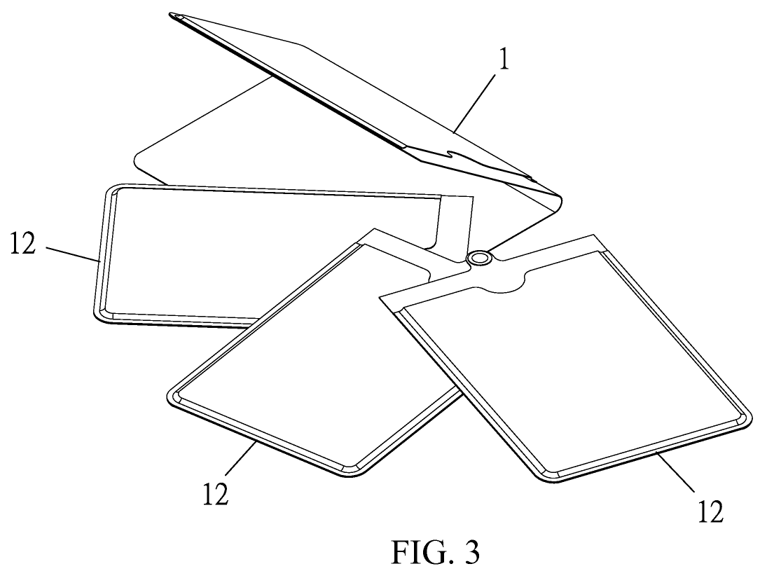

Referring collectively to FIGS. 1-3, which are respectively a perspective view and a cross-sectional view of a compound name-card-shaped proximity card holder according to the present invention and a schematic view illustrating an operation of the compound name-card-shaped proximity card holder, reference being also made to FIG. 2A, as shown in the drawings, the present invention provides a compound name-card-shaped proximity card holder, which comprises: a main body 1. The main body 1 comprises a first pocket 11, a plurality of interlayers 12, and a second pocket 13. The first pocket 11 and the main body 1 form a first receiving compartment 111 and the second pocket 13 and the main body 1 form a second receiving compartment 131. The first receiving compartment 111 and the second receiving compartment 131 both can receive and hold therein various sorts of articles, such as cards and proximity cards. The interlayers 12 are arranged in the interior of the main body 1 and are fixed by a circular button 121 to the main body 1 in such a way as to be rotatable out of the main body 1. The interlayers 12 are each simply an open-end folder that allows a single proximity card to be inserted therein. The main body 1 can be formed of a FAM film or a thin metal sheet. Except the main body, the holder in the entirety thereof is made of materials in the form of thin films. The thin film material can be leather or plastics, such as PVC and PE. As such, a compound name-card-shaped proximity card holder is formed.

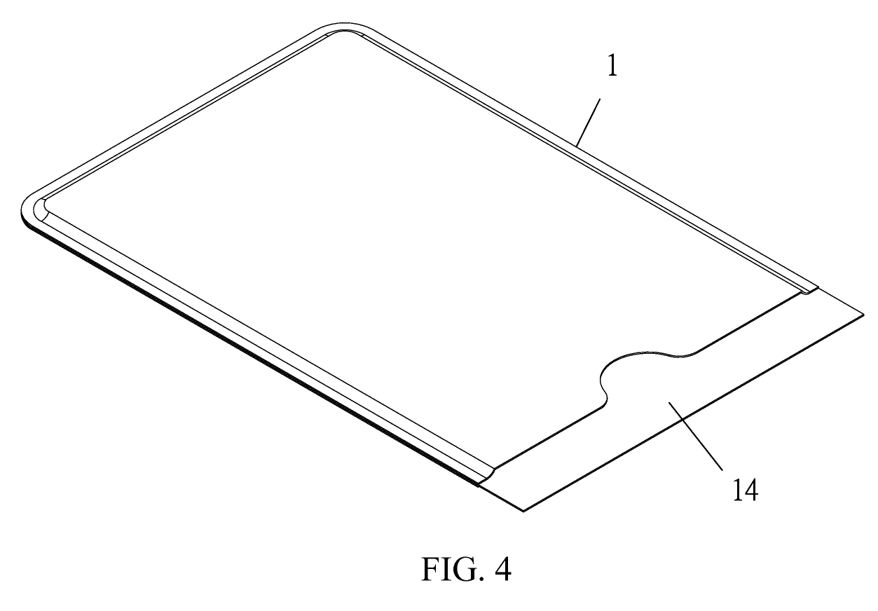

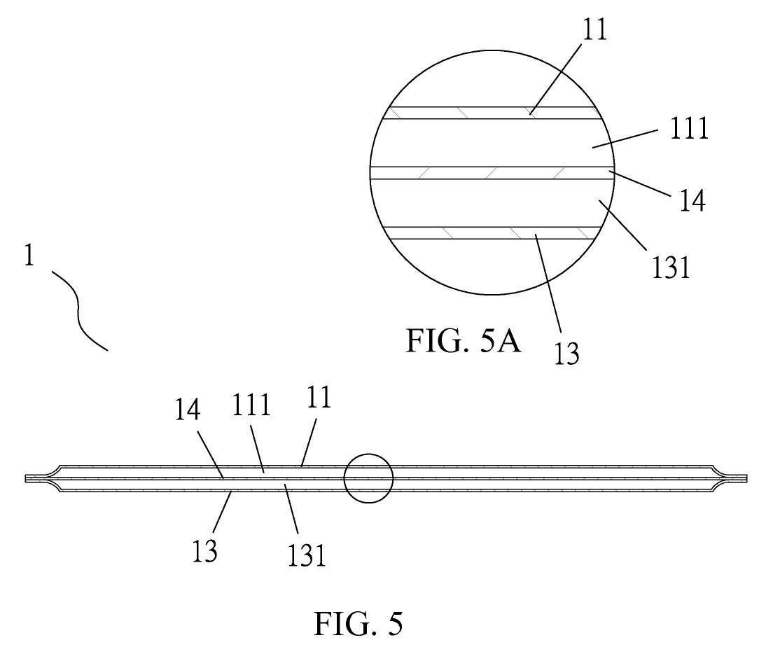

Also referring to FIGS. 4 and 5, which are respectively a perspective view and a cross-sectional view of a compound name-card-shaped proximity card holder according to the present invention, these drawings show another object of the present invention is to provide a compound name-card-shaped proximity card holder, which as shown in the drawings, comprises: a main body 1. The main body 1 comprises a first pocket 11, an isolation layer 14, and a second pocket 13. The first pocket 11 and the main body 1 form a first receiving compartment 111. The second pocket 13 and the main body 1 form a second receiving compartment 131. The first receiving compartment 111 and the second receiving compartment 131 receive and hold therein various sorts of articles, such as cards and proximity cards. The isolation layer 14 is arranged between the first receiving compartment 111 and the second receiving compartment 131 to isolate proximity cards received in the compartments to prevent mutual influence and demagnetization therebetween. The isolation layer 14 can be formed of a FAM film or a thin metal sheet. Except the isolation layer 14, the main body 1, in the entirety thereof, is made of materials in the form of thin films. The thin film material can be leather or plastics, such as PVC and PE. As such, a compound name-card-shaped proximity card holder is formed.

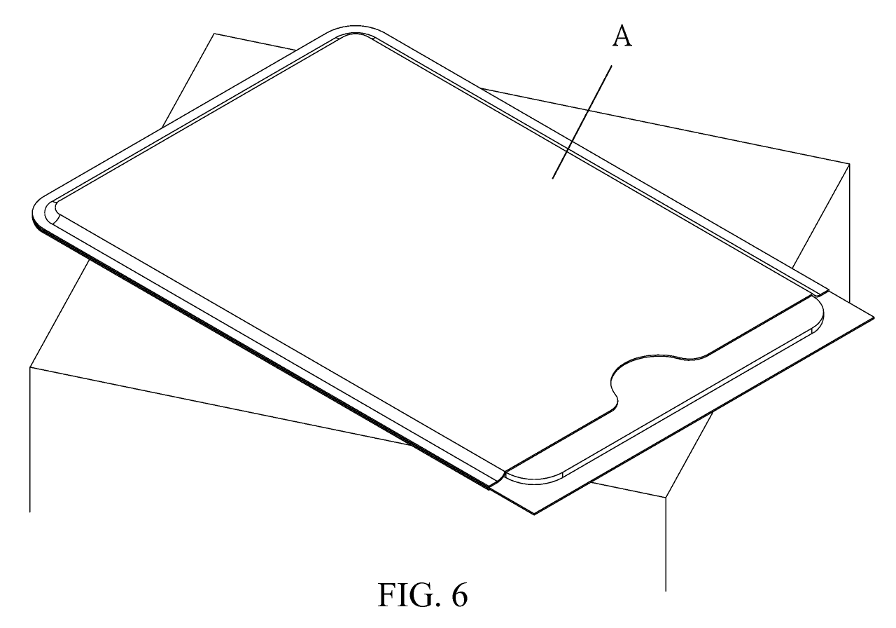

Finally, referring to FIG. 6, which is a schematic view showing an example of the use of the compound name-card-shaped proximity card holder of the present invention, as shown in the drawing, the compound name-card-shaped proximity card holder A of the present invention makes use of the arrangement of an interlayer formed of a thin metal sheet or a FAM film in the main body to provide an effect of isolation so as to prevent proximity cards placed on inside and outside from mutually influencing or demagnetizing each other. Further, the interlayer, being in a simple form of an open-end folder, allows for insertion and storage of a single proximity card therein and is fixed by a circular button to the main body to be rotatable out of the main body so as to provide an effect that the proximity card received in the interlayer is readily rotated out for detection and reading. Mutual influence between opposite sides or multiple layers can be prevented and demagnetization can also be avoided.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A compound proximity card holder, comprising:
a main body, which comprises a first pocket and a second pocket that are connected to each other and a plurality of interlayers arranged between the first and second pockets,
wherein the first pocket of the main body forms a first receiving compartment and the second pocket of the main body forms a second receiving compartment, the first receiving compartment and the second receiving compartment being adapted to each receive and hold therein articles including proximity cards, the interlayers being arranged between the first pocket and the second pocket of the main body and fixed by a circular button to the main body to be rotatable between a first position of being interposed between and covered by the first and second pockets in the closed position and a second position of being at least partly projecting beyond edges of the first and second pockets, the interlayers each being in the form of an open-end folder that is adapted to receive insertion of a single proximity card; and
wherein an isolation layer is arranged between the first and second pockets to isolate the proximity cards received in the first and second pockets from each other so as to protect the proximity cards from being demagnetized and mutually influencing each other and wherein the interlayers are each formed of a film that provides an effect of isolation so as to prevent the proximity cards received therein and proximity cards placed outside the interlayers from mutually influencing or demagnetizing each other.

2. The compound proximity card holder according to claim 1, wherein the main body is formed of a thin metal sheet.

3. The compound proximity card holder according to claim 1, wherein the interlayers are formed of a material in the form of a thin film.

4. The compound proximity card holder according to claim 3, wherein the thin film material comprises leather or plastics that include one of polyvinylchloride (PVC) and polyethylene (PE).

5-8. (canceled)
